(19) United States
(12) Patent Application Publication
(10) Pub. No.: US 2022/0369662 A1
(43) Pub. Date: Nov. 24, 2022

(54) EDIBLE PONGAMIA COMPOSITIONS, AND METHODS OF PREPARING AND USING THEREOF

(71) Applicant: Terviva, Inc., Oakland, CA (US)

(72) Inventors: Naveen SIKKA, Oakland, CA (US); William Newell KUSCH, Oakland, CA (US); Vamsi Krishna RANI, Oakland, CA (US); James D. ASTWOOD, Alameda, CA (US); Jake Matthew OLSON, Oakland, CA (US); Henok BELAYNEH, Oakland, CA (US)

(73) Assignee: Terviva, Inc., Oakland, CA (US)

(21) Appl. No.: 17/765,646

(22) PCT Filed: Oct. 2, 2020
(86) PCT No.: PCT/US2020/053945

§ 371 Date: Mar. 31, 2022

Related U.S. Application Data
(60) Provisional application No. 62/910,315, filed on Oct. 3, 2019.

(51) Int. Cl. A23J 1/14; A23K 10/30; A23K 20/147; A23K 20/111; A23K 20/163; A23K 50/75; A23L 33/185; A23L 33/125; A23L 33/16

(52) U.S. Cl. CPC A23J 1/142; A23K 10/30; A23K 20/147; A23K 20/111; A23K 20/163; A23K 50/75; A23L 33/185; A23L 33/125; A23L 33/16; A23V 2002/00

(57) ABSTRACT

Provided herein are compositions obtained from processing pongamia oilseeds. The resulting pongamia compositions may be in the form of meal, and have an optimized nutritional composition achieved by subjecting pongamia oilseeds to certain processing steps. The resulting pongamia compositions may also have reduced levels of karanjin, pongamol and tannins. Such pongamia compositions may be suitable as food or food ingredients to humans and other animals.

### CROSS-REFERENCE TO RELATED APPLICATION

This application claims priority to U.S. Provisional Patent Application No. 62/910,315, filed Oct. 3, 2019, which is incorporated herein by reference in its entirety.

### FIELD

The present disclosure relates generally to compositions obtained from pongamia oilseeds, and more specifically to pongamia compositions having an optimized nutritional composition, achieved by subjecting pongamia oilseeds to certain processing steps. Such pongamia compositions may be suitable as food or food ingredients to humans and other non-ruminant animals, such as poultry, swine, canines and felines.

### BACKGROUND

Growing concerns related to population growth, climate change and the viability of existing agricultural practices over the next several decades have led to a surge in the research and development of alternative food sources to ensure future global food security. Renewable plant-based sources have prompted significant interest as an environmentally friendly and sustainable means to alleviate pressure on the worldwide food supply by providing nutrient- and protein-rich alternatives to animal-derived protein in human diets.

Millettia pinnata, also known as Pongamia pinnate or Pongamia glabra, or more colloquially as pongamia or karanja, is tree that is common throughout Asia and may provide a major source for future plant-based protein. Pongamia trees use one-tenth of the land as required for soybean plants to produce the same amount of beans. Pongamia trees can grow on degraded sail, and allow for avoidance of deforestation issues created by soybeans, Pongamia also produces much larger amounts of protein and vegetable oil per acre than soybean. Pongamia seedcake, the byproduct of oil extraction from pongamia oil seeds, offers a potential renewable source of protein, carbohydrates and fibers for use in foodstuffs comparable to soy. However, pongamia oilseeds also have other components that are known in the art to have disagreeable taste and odor, including karanjin and pongamol. It is desirable to minimize the amount of karanjin and pongamol in the seedcake for use as a viable food. source.

The widespread use of pongamia-derived foodstuffs is currently prevented by the absence of methods for preparing pongamia compositions having low levels of karanjin and pongamol while maintaining the high nutritional content (proteins, carbohydrates, etc.) intrinsic to the oilseeds. Existing methods for the removal of these undesirable components in pongamia seedcake often require harsh, destructive conditions that reduce and degrade the nutrients to the point that the nutritional value of pongamia is severely impacted. The lack of methods for producing pongamia compositions having the critical balance of preserved nutritional content and sufficiently low levels of anti-nutrients have precluded the incorporation of pongamia-derived protein as a replacement food source on a large enough scale to remain economically feasible.

Thus, what is desired in the art are commercially viable methods to obtain edible compositions from pongamia oil seeds that retain an optimal nutritional balance, while minimizing components such as karanjin and pongamol.

### BRIEF SUMMARY

Provided herein are compositions obtained by processing pongamia oilseeds under certain conditions to obtain a composition suitable for consumption by humans and other animals.

In some aspects, provided is a pongamia composition, comprising: karanjin or pongamol, or both; tannins; digestible proteins; carbohydrates; antioxidants; and minerals. In some embodiments, the composition has: (i) a karanjin content, if present, of less than or equal to 100 ppm; (ii) a pongamol content, if present, of less than or equal to 100 ppm; and (iii) a tannin content of less than or equal to 0.5% w/w. In some variations, the composition is in the form of meal. In certain variations, the composition is in the form of flour.

In other aspects, provided are methods of preparing such pongamia compositions. In some embodiments, the method comprises: heating pongamia oilseeds at a temperature between 25° C. and 200° C. for a suitable time to provide treated oilseeds; dehulling the treated oilseeds to produce dehulled oilseeds; mechanically pressing the dehulled oilseeds to produce a deoiled seedcake; combining the deoiled seedcake with solvent to provide an extraction mixture, wherein the solvent comprises alkyl alkanoate or alcohol, or any combination thereof; and separating the extraction mixture into a miscella and the pongamia composition. In some variations, the mechanical pressing is performed by an expeller or an expander.

In yet other aspects, the pongamia. compositions provided herein are formulated into feed compositions, suitable for feeding to humans and other non-ruminant animals. In some embodiments, provided is a method comprising feeding any of the pongamia compositions described herein to a non-ruminant animal.

In yet other aspects, provided are feed compositions that comprise the pongamia compositions provided herein. In one variation, provided is a poultry feed, comprising: a base feed; and any of the pongamia compositions described herein. In another variations, provided is a poultry feed, comprising; corn; a soybean supplement; and any of the pongamia compositions described herein.

In still other aspects, provided are food compositions that comprise the pongamia compositions provided herein. In some variations, provided is a food composition, wherein the food composition is a confection, condiment, cereal composition, baked good, baking good, cooking adjuvant, dairy product, dietary supplement, tabletop sweetener composition beverage, or other beverage product.

### DESCRIPTION OF THE FIGURES

The present application can be best understood by reference to the following description taken in conjunction with the accompanying figures, in which like parts may be referred to by like numerals.

FIG. 1 depicts an exemplary process for preparing an edible pongamia composition.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

### Pongamia Compositions

In some aspects, provided herein are edible compositions obtained from processing pongamia, oilseeds to maximize removal certain anti-nutritional components therein, such as karanjin, pongamol and tannins, while optimizing the nutritional balance of other components therein, such as digestible proteins, carbohydrates, antioxidants, and minerals.

As used herein, the components of the pongamia compositions described herein, such as karanjin, pongamol, tannins, digestible proteins, carbohydrates, antioxidants, and minerals are referring to components endogenous to the pongamia oilseed from which the composition is obtained.

Pongamia oilseeds are known to contain high concentrations of a class of flavonoids possessing a furan ring, known as furanoflavonoids, most notably karanjin and pongamol. Furanoflavonoids may be further identified by sub-classes including, for example, flavones, flavonols (e.g., karanjin) and dibenzoylmethanes pongamol). Karanjin (left) and pongamol (right) have the following structures, respectively;

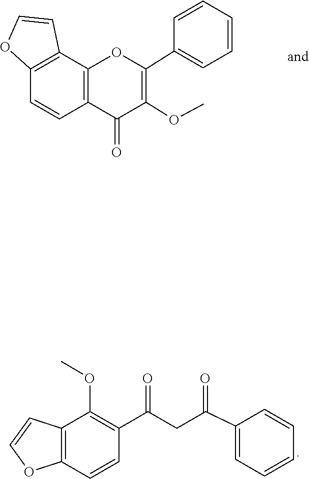 [SMILES: COc1c(-c2ccccc2)oc2c(ccc3occc32)c1=O ; COc1c(C(=O)CC(=O)c2ccccc2)ccc2occc12]

In certain aspects, provided is an edible pongamia composition, comprising: karanjin or pongamol, or both; tannins; digestible proteins; carbohydrates; antioxidants; and minerals. In some embodiments, the composition has: (i) a karanjin content, if present, of less than or equal to 100 ppm; (ii) a pongamol content, if present, of less than or equal to 100 ppm; and (iii) a tannin content of less than or equal to 0.5% w/w.

In some variations, the karanjin content and/or pongamol content (where present) is independently less than or equal to 90 ppm, less than or equal to 80 ppm, less than or equal to 70 ppm, less than or equal to 60 ppm, less than or equal to 50 ppm, less than or equal to 40 ppm, less than or equal to 30 ppm, less than or equal to 20 ppm, less than or equal to 10 ppm, less than or equal to 5 ppm, less than or equal to 2 ppm, less than or equal to 1 ppm, or less than or equal to 0.5 ppm, or less than or equal to 0.1 ppm. In certain embodiments, the pongamia composition has a karanjin concentration and/or a pongamol concentration on the order of single digit parts-per-million, or fractional amounts thereof. In some embodiments, the pongamia composition has a karanjin concentration and/or a pongamol concentration of at least 0.001 ppm, at least 0.01 ppm, or at least 0.1 ppm. In certain variations, the pongamia composition has a karanjin content and/or pongamol content of between 0.001 ppm and 100 ppm, between 0.001 ppm and 90 ppm, between 0.001 ppm and 80 ppm, between 0.001 ppm and 70 ppm, between 0.001 ppm and 60 ppm, between 0.001 ppm and 50 ppm, between 0.001 ppm and 40 ppm, between 0.001 ppm and 30 ppm, between 0.001 ppm and 20 ppm, between 0.001 ppm and 10 ppm, between 0.001 ppm and 5 ppm, between 0.001 ppm and 2 ppm, between 0.001 ppm and 1 ppm, 0.001 ppm and 0.5 ppm, between 0.001 ppm and 0.1 ppm, between 0.01 ppm and 100 ppm, between 0.01 ppm and 90 ppm, between 0.01 ppm and 80 ppm, between 0.01 ppm and 70 ppm, between 0.01 ppm and 60 ppm, between 0.01 ppm and 50 ppm, between 0.01 ppm and 40 ppm, between 0.01 ppm and 30 ppm, between 0.01 ppm and 20 ppm, between 0.01 ppm and 10 ppm, between 0.01 ppm and 5 ppm, between 0.01 ppm and 2 ppm, between 0.01 ppm and 1 ppm, between 0.01 ppm and 0.5 ppm, 0.01 ppm and 0.1 ppm, between 0.1 ppm and 100 ppm, between 0.1 ppm and 90 ppm, between 0.1 ppm and 80 ppm, between 0.1 ppm and 70 ppm, between 0.1 ppm and 60 ppm, between 0.1 ppm and 50 ppm, between 0,1 ppm and 40 ppm, between 0,1 ppm and 30 ppm, between 0.1 ppm and 20 ppm, between 0.1 ppm and 10 ppm, between 0.1 ppm and 5 ppm, between 0.1 ppm and 2 ppm, between 0.1 ppm and 1 ppm, between 0.1 ppm and 0.5 ppm, between 1 ppm and 100 ppm, between 1 ppm and 50 ppm, between 1 ppm and 20 ppm, between 1 ppm and 10 ppm, between 1 ppm and 5 ppm, or between 1 ppm and 2 ppm, In some embodiments, the pongamia compositions may have concentrations of karanjin and/or pongamol of less than 100 ppm, which are non-detectable by traditional hexane- and methanol-based analytical methods. In still further embodiments, the pongamia composition may have trace concentrations of karanjin and/or pongamol, on the order of parts-per-billion (ppb) or parts-per trillion In some embodiments, the pongamia compositions described herein may comprise trace amounts of karanjin and/or pongamol that are non-detectable by the alkyl alkanoate-based microwave-assisted solvent extraction analytical methods described herein.

Similarly, the pongamia compositions of the present disclosure may have very low tannin content to the level of being non-detectable.

In some variations, the tannin content is less than or equal to 0.4% w/w, or less than or equal to 0.3% w/w. In still other variations, the tannin content is less than or equal to 0.2% w/w, less than or equal to 0.1% w/w, less than or equal to 0.01% w/w, or less than or equal to 0.001% w/w. In some embodiments wherein the pongamia compositions have a detectable tannin content, the tannin content of the pongamia compositions is at least 0.001% w/w, at least 0.01% w/w, or at least 0.01% w/w. In certain variations, the tannin content is between 0.001% w/w and 0.4% w/w, between 0.001% w/w and 0.3% w/w, between 0.001% w/w and 0.2% w/w, between 0.001% w/w and 0.1% w/w, between 0.001% w/w and 0.01% w/w, between 0.01% w/w and 0.4% w/w, between 0.01% w/w and 0.3% w/w, between 0.01% w/w and 0.2% w/w, between 0.01% w/w and 0.1% w/w, between 0.1% w/w and 0.4% w/w, between 0.1 w/w and 0.3% w/w, between 0.1% w/w and 0.2% w/w, between 0.2% w/w and 0.4% w/w, between 0.2% w/w and 0.3% w/w, or between 0.3% w/w and 0.4% w/w.

In other embodiments, the composition further comprises other furanoflavonoids that may be present in the pongamia oilseeds from which the pongamia composition was obtained. Such furanoflavonoids may include, for example, lanceolatin, kanjone, pongaglabrone, pongaglabol, ovalifolin, sanaganone, pinnatin, gamatin, pongone, glabone, karanjonol, pongapin, pachycarin, pongaglahol methyl ether, isopongaglabol, methoxyisopongaglabol, pongol methyl ether, millettocalyxin, 6-methoxyisopongaglabol, pongamoside A, pongamoside B, ponganone XI, pongamoside C, glabra I, ovalitenone, ponganone IX, and pongarotene.

In some variations of the foregoing, the pongamia composition has a balance of digestible proteins, carbohydrates, antioxidants, and minerals to increase bioavailability in humans and other non-ruminant animals.

In some variations of the foregoing, the pongamia composition is in the form of meal. In other variations of the foregoing, the pongamia composition is in the form of flour.

In some embodiments, the pongamia compositions of the present disclosure may have a karanjin content, if present, of less than or equal to 100 ppm; (ii) a pongamol content, if present, of less than or equal to 100 ppm; and (iii) a tannin content of less than or equal to 0.5% w/w. In other embodiments, the pongamia compositions of the present disclosure may have (i) a karanjin content, if present, of less than or equal to 100 ppm, less than or equal to 90 ppm, less than or equal to 80 ppm, less than or equal to 70 ppm, less than or equal to 60 ppm, less than or equal to 50 ppm, less than or equal to 40 ppm, less than or equal to 30 ppm, less than or equal to 20 ppm, less than or equal to 10 ppm, less than or equal to 5 ppm, less than or equal to 2 ppm, less than or equal to 1 ppm, or less than or equal to 0.5 ppm, or less than or equal to 0.1 ppm; (ii) a pongamol content, if present, of less than or equal to 100 ppm, less than or equal to 90 ppm, less than or equal to 80 ppm, less than or equal to 70 ppm, less than or equal to 60 ppm, less than or equal to 50 ppm, less than or equal to 40 ppm, less than or equal to 30 ppm, less than or equal to 20 ppm, less than or equal to 10 ppm, less than or equal to 5 ppm, less than or equal to 2 ppm, less than or equal to 1 ppm, or less than or equal to 0.5 ppm, or less than or equal to 0.1 ppm; and (iii) a tannin content of less than or equal to 0.5% w/w, less than or equal to 0.4% w/w, or less than or equal to 0.3% w/w. In still other variations, the tannin content is less than or equal to 0.2% w/w, less than or equal to 0.1% w/w, less than or equal to 0.01% w/w, or less than or equal to 0.001% w/w.

In some embodiments of the foregoing wherein the pongamia compositions of the present disclosure may have (i) a karanjin content, if present, of less than or equal to 100 ppm; (ii) a pongamol content, if present, of less than or equal to 100 ppm; and (iii) a tannin content of less than or equal to 0.5% w/w, the pongamia compositions may be further characterized by various organoleptic properties, such as taste, palatability, and sensory acceptability.

For example, color may be indicative of, or a proxy for, the tannin content in the pongamia compositions. In still further embodiments, which may be combined any of the foregoing embodiments, the pongamia compositions described herein may color characteristics as determined by a ultra-violet-visible light spectral absorption profile or visual comparison to suitable color standard (card) (e.g., USDA color standard). In certain embodiments, the pongamia composition is white.

Methods of Preparing Pongamia Compositions

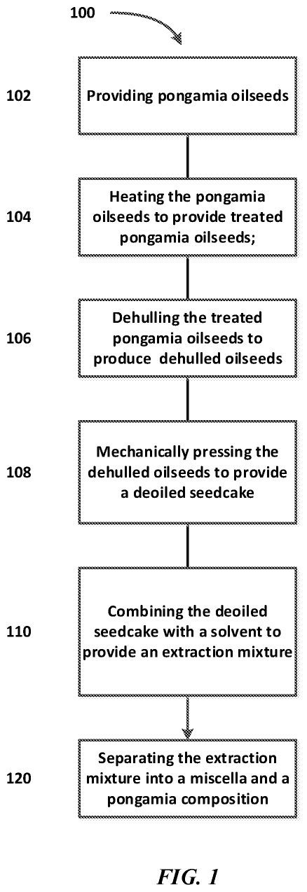

The pongamia compositions described herein are obtained from pongamia oilseeds, and undergo certain thermal and mechanical processing steps. With reference to FIG. 1, process 100 is an exemplary process to prepare a pongamia composition. In step 102, pongamia oilseeds are provided. In some variations, providing the oilseeds may further include removing and/or separating the oilseeds from the pods, or shells. The removal of the oilseeds from their pods or shells may involve manual removal or mechanical cracking to open the pods. In certain variations, the separation of oilseeds from their pods or shells may involve manual separation, sieving/screening, or aerodynamic separation (e.g., weight classification by aspiration).

With reference again to FIG. 1, the pongamia oilseeds are heated at a suitable temperature for a suitable amount of time in step 104, thereby providing treated pongamia oilseeds. The thermal treatment may help to promote the disintegration of the membrane binding the oilseeds to their hulls and, consequently, may facilitate the downstream removal of the hulls from the treated oilseeds. In some embodiments, the temperature and duration of the thermal treatment may influence the compatibility of the downstream dehulled oilseeds with the mechanical pressing process.

In some embodiments, the oilseeds are heated at a temperature of at least 25° C., at least 30° C., at least 35° C., at least 40° C., at least 50° C., at least 60° C., at least 70° C., at least 75° C., at least 80° C., at least 90° C., at least 100° C., at least 110° C., at least 120° C., at least 125° C., at least 130° C., at least 140° C., at least 150° C., at least 160° C., at least 170° C., at least 175° C., at least 180° C., or at least 190° C. In other embodiments, the oil seeds are heated at a temperature of less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 125° C., less than or equal to 120° C., less than or equal to 110° C., less than or equal to 100° C., less than or equal to 90° C., less than or equal to 80° C., or less than or equal to 75° C. In some variations, the oilseeds are heated at a temperature between 25° C. and 200° C., between 30° C. and 200° C., between 60° C. and 200° C., between 60° C. and 180° C., between 60° C. and 150° C., between 60° C. and 120° C., between 80° C. and 200° C., between 80° C. and 180° C., between 80° C. and 150° C., between 80° C. and 120° C., between 100° C. and 200° C., between 100° C. and 180° C., between 100° C. and 150° C., between 100° C. and 120° C., between 120° C. and 200° C., between 120° C. and 180° C., between 120° C. and 150° C., between 150° C. and 200° C., between 150° C. and 180° C., or between 180° C. and 200° C.

In some variations, the oilseeds are heated for a period of time of at least 5 minutes, at least 10 minutes, at least 15 minutes, at least 20 minutes, at least 25 minutes, at least 30 minutes, at least 45 minutes, at least 1 hour, at least 90 minutes, at least 120 minutes, at least 150 minutes or at least 180 minutes. In other variations, the oil seeds are heated for a period of time of less than or equal to 1 day, less than or equal to 20 hours, less than or equal to 15 hours, less than or equal to 10 hours, less than or equal to 5 hours, less than or equal to 4 hours, less than or equal to 180 minutes, less than or equal to 120 minutes, less than or equal to 90 minutes, less than or equal to 60 minutes, less than or equal to 45 minutes, less than or equal to 30 minutes. less than or equal to 25 minutes, less than or equal to 20 minutes, less than or equal to 15 minutes, or less than or equal to 10 minutes. In other variations, the oilseeds are heated for a period of time between 5 minutes and 3 hours, between 5 minutes and 2 hours, between 5 minutes and 90 minutes, between 5 minutes and 1 hour, between 5 minutes and 30 minutes, between 5 minutes and 15 minutes, between 15 minutes and 3 hours, between 15 minutes and 2 hours, between 15 minutes and 90 minutes, between 15 minutes and 1 hour, between 15 minutes and 30 minutes, between 30 minutes and 3 hours, between 30 minutes and 2 hours, between 30 minutes and 90 minutes, between 30 minutes and 1 hour, or between 30 minutes and 45 minutes. Suitable temperatures and/or residence times for the thermal treatment may encompass any combination of time and temperature as described herein. For example, in one variation, the oilseeds are heated at a temperature between 25° C. and 200° C. for a period of time between 5 minutes and 3 hours. In some variations, the oilseeds are heated for a period of time between 5 minutes and 3 hours, between 5 minutes and 2 hours, between 5 minutes and 90 minutes, between 5 minutes and 1 hour, between 5 minutes and 30 minutes, between 5 minutes and 15 minutes, between 15 minutes and 3 hours, between 15 minutes and 2 hours, between 15 minutes and 90 minutes, between 15 minutes and 1 hour, between 15 minutes and 30 minutes, between 30 minutes and 3 hours, between 30 minutes and 2 hours, between 30 minutes and 90 minutes, between 30 minutes and 1 hour, or between 30 minutes and 45 minutes, at a temperature of between 25° C. and 200° C., between 30° C. and 200° C., between 60° C. and 200° C., between 60° C. and 180° C., between 60° C. and 150° C., between 60° C. and 120° C., between 80° C. and 200° C., between 80° C. and 180° C., between 80° C. and 150° C., between 80° C. and 120° C., between 100° C. and 200° C., between 100° C. and 180° C., between 100° C. and 150° C., between 100° C. and 120° C., between 120° C. and 200° C., between 120° C. and 180° C., between 120° C. and 150° C., between 150° C. and 200° C., between 150° C. and 180° C., or between 180° C. and 200° C.

With reference again to FIG. 1, the treated oilseeds are then dehulled in step 106. Any suitable techniques known in the art to remove the hulls from the oilseeds may be employed. For example, in some variations, the treated oilseeds are subjected to abrasive force in order to remove the hulls. In certain variations, dehulling may be carried out with an attrition mill or an impeller, or mechanical equivalent. In one variation, the dehulling step does not utilize wet removal methods, such as blanching, alkaline and/or aqueous dissolution. In certain embodiments, the pongamia oilseeds undergo thermal treatment prior to hull removal. In some variations, such thermal treatment is a dry dehulling process, which is distinguished from a wet dehulling process that may involve, for example, blanching. In certain embodiments, the pongamia oilseeds subjected to the thermal treatment and the oilseeds and pongamia composition obtained therefrom as described herein may be characterized by their moisture content. In some variations, the treated oilseeds obtained from the thermal treatment have a moisture content of less than or equal to 20% w/w, less than or equal to 17% w/w, less than or equal to 15% w/w, less than or equal to 12% w/w, less than or equal to 10% w/w, or less than or equal to 8% w/w, without further drying. In other variations, the treated oilseeds obtained from the thermal treatment have a moisture content of between 5% w/w and 20% w/w, between 5% w/w and 17% w/w, between 5% w/w and 15% w/w between 5% w/w and 12% w/w, between 5% w/w and 10% w/w, between 5% w/w and 8% w/w, between 8% w/w and 20% w/w, between 8% w/w and 17% w/w, between 8% w/w and 15% w/w, between 8% w/w and 12% w/w, between 8% w/w and 10% w/w, between 10% w/w and 20% w/w, between 10% w/w, and 17% w/w, between 10% w/w and 15% w/w, between 10% w/w and 12% w/w, between 12% w/w and 20% w/w, between 12% w/w and 17% w/w, between 12% w/w and 15% w/w, between 15% w/w and 20% w/w, between 15% w/w and 17% w/w, or between 17% w/w and 20% w/w, without further drying. In yet other variations, the treated oilseeds obtained from the thermal treatment may be dried in order to control the moisture content prior to mechanical processing to remove oil and obtain a deoiled seedcake (or presscake).

The dehulled oilseeds may be described by any number of characteristics, including for example the weight percentage of oilseeds that are dehulled, the tannin content, the moisture content, or the particle size distribution. In some embodiments, the percentage of oilseeds that are dehulled may be quantified by visual inspection of the covered and uncovered surface area of the oilseeds. In certain variations, the dehulled oilseeds has between 40% w/w and 100% w/w, between 40% and 80% w/w, or between 40% and 70% w/w of oilseeds having less than 50% of the total surface area covered by hull. In certain variations, the dehulled oilseeds have an average tannin content of less than or equal to 0.5% w/w, less than or equal to 0.4% w/w, or less than or equal to 0.3% w/w. In still other variations, the dehulled oilseeds have an average tannin content of less than or equal to 0.2% w/w, less than or equal to 0.1% w/w, less than or equal to 0.01% w/w, or less than or equal to 0.001% w/w. In some variations, the dehulled oilseeds have an average tannin content of at least 0.001% w/w, at least 0.01% w/w, or at least 0.01% w/w. In certain variations, the tannin content is between 0.001% w/w and 0.4% w/w, between 0.001% w/w and 0.3% w/w, between 0.001% w/w and 0.2% w/w, between 0.001% w/w and 0.1% w/w, between 0.001% w/w and 0.01% w/w, between 0.01% w/w and 0.4% w/w, between 0.01% w/w and 0.3% w/w, between 0.01% w/w and 0.2% w/w, between 0.01% w/w and 0.1% w/w, between 0.1% w/w and 0.4% w/w, between 0.1% w/w and 0.3% w/w, between 0.1% w/w and 0.2% w/w, between 0.2% w/w and 0.4% w/w, between 0.2% w/w and 0.3% w/w, or between 0.3% w/w and 0.4% w/w.

In some variations, removing the hulls from the treated pongamia oilseeds results in a mixture comprising dehulled oilseeds and detached hulls. As such, the method may further comprise separating the detached hulls from the dehulled oilseeds. In some embodiments, the method further comprises separating the, dehulled oilseeds from the detached hulls by hand separation, by sieving or screening, or aerodynamic separation (i.e., weight classification by aspiration).

With reference again to FIG. 1, in step 108, the dehulled oilseeds are mechanically pressed to remove oil and to provide a deoiled seedcake (or presscake). In some variations, the dehulled oilseeds are mechanically pressed using an expeller press. In other variations, the dehulled oilseeds are mechanically pressed using an expander. In still other variations, the dehulled oilseeds are mechanically pressed using an extruder. One or more iterations of the mechanical pressing step may be applied to the dehulled oilseeds and/or resulting deoiled seedcake to provide the final deoiled seedcake used in the subsequent solvent extraction step. In other embodiments, the deoiled seedcake may be further cracked, prior to solvent extraction, to provide a deoiled seedcake having a certain particle size distribution.

The deoiled seedcake may be described by other attributes including, for example, karanjin concentration, oil content, moisture content, and particle size distribution. For example, in some embodiments, the deoiled seedcake has a karanjin concentration of at least 200 ppm, or at least 500 ppm. In some embodiments, the deoiled seedcake has 8-40% oil by weight, 10-35% oil by weight, or 8-30% oil by weight.

With reference again to FIG. 1, in step 110, the deoiled seedcake undergoes solvent extraction. In some variations, the deoiled seedcake, is combined with the solvent in an extractor. In certain variations, the deoiled seedcake and the solvent undergoes mixing, agitating, or stirring in an extractor. In some variations, heat may be applied in the solvent extraction step. It should be noted that the foregoing methods may include variations of other parameters that may be part of the combining step including, for example, the residence time of the extraction mixture in the extractor, extractor temperature and pressure, extractor chain speed, particle size distribution of the deoiled seedcake, the ratio of deoiled seedcake to the solvent and feed rates of the deoiled seedcake and solvent into the extractor.

In some embodiments, the solvent comprises alkyl alkanoate or alcohol, or any combination thereof. In one embodiment, the solvent comprises alcohol. Alcohol solvent may include, for example, methanol, propanol, ethanol, butanol, or pentanol.

In another embodiment, the solvent comprises alkyl alkanoate. In certain variations, the alkyl of the alkyl alkanoate is methyl, ethyl, propyl, or butyl. In certain variations, the solvent comprises a methyl alkanoate, an ethyl alkanoate, a propyl alkanoate, or a butyl alkanoate, or any combinations thereof. In other variations, the alkanoate of the alkyl alkanoate is methanoate, ethanoate, propionate, butanoate, or pentanoate. In other variations, the solvent comprises an alkyl methanoate, an alkyl ethanoate, an alkyl propionate, an alkyl butanoate, an alkyl pentanoate, or any combination thereof. In certain variations, the solvent comprises an alkyl ethanoate. In certain embodiments, the solvent comprises ethyl acetate. Alkyl alkanoate solvent may include, for example, methyl methanoate, methyl ethanoate, methyl propanoate, methyl butanoate, methyl pentanoate, ethyl methanoate, ethyl ethanoate, ethyl propanoate, ethyl butanoate, ethyl pentanoate, propyl methanoate, propyl ethanoate, propyl propanoate, propyl butanoate, propyl pentanoate, butyl methanoate, butyl ethanoate, butyl propanoate, butyl butanoate, and butyl pentanoate, and any combinations thereof. In certain embodiments, the solvent comprises an alkyl alkanoate solvent selected from the group consisting of methyl ethanoate, methyl propanoate, methyl butanoate, ethyl methanoate, ethyl ethanoate, ethyl propanoate, ethyl butanoate, propyl methanoate, propyl ethanoate, propyl propanoate, propyl butanoate, butyl methanoate, butyl ethanoate, butyl propanoate, and butyl butanoate.

In one embodiment, the solvent comprises an alkyl alkanoate of formula (I):

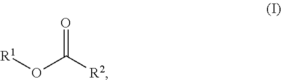

wherein
R¹ is a C₁-C₄ alkyl; and
R² is hydrogen or a C₁-C₄ alkyl.

In some variations, R¹ is a C₁-C₄ alkyl. In other variations, R² is hydrogen or a C₁-C₄ alkyl. In certain variations, R¹ and R² are independently C₁-C₄ alkyl. In certain other variations, R¹ is C₁-C₄ alkyl and R² is hydrogen. In some variations wherein R¹ is a C₁-C₄ alkyl, R¹ is CH₃—, CH₃CH₂—, CH₃CH₂CH₂—, (CH₃)₂CH—, CH₃CH₂CH₂CH₂—, CH₃CH₂(CH₃)CH—, (CH₃)₂CHCH₂—, or (CH₃)₃C—. In some variations, R² is hydrogen. In other variations, R² is a C₁-C₄ alkyl. In certain variations wherein R² is a C₁-C₄ alkyl, R² is CH₃—, CH₃CH₂—, CH₃CH₂CH₂—, (CH₃)₂CH—, CH₃CH₂CH₂CH₂—, CH₃CH₂(CH₃)CH—, (CH₃)₂CHCH₂—, or (CH₃)₃C—. In certain variations, R² is hydrogen, CH₃—, CH₃CH₂—, or CH₃CH₂CH₂—. In still yet other variations, R¹ is CH₃CH₂— and R² is CH₃—. In some variations, R¹ is CH₃CH₂— or CH₃CH₂CH₂CH₂—, and R² is hydrogen. In other variations, R¹ is CH₃CH₂CH₂— and R² is CH₃CH₂CH₂— or CH₃CH₂CH₂CH₂—. In other variations, R¹ is a C₁-C₃ alkyl. In yet other variations, R¹ is methyl, ethyl, n-propyl, or isopropyl. In certain variations, R¹ is ethyl. In some variations, R¹ is a C₂-C₄ alkyl. In certain variations, R¹ is ethyl, n-propyl, isopropyl, n-butyl, sec-butyl, isobutyl, or t-butyl. In other variations, R² is hydrogen or a C₁-C₃ alkyl. In certain variations, R² is methyl, ethyl, n-propyl, or isopropyl. In certain variations, R² is methyl. In yet other variations, R¹ is ethyl and R² is methyl. In still other variations, R² is hydrogen, ethyl or n-propyl. In yet further variations R¹ is ethyl, n-propyl, or n-butyl, and R² is hydrogen, methyl, ethyl, or n-propyl. In certain variations, R² is methyl. In yet other variations, R¹ is ethyl and R² is methyl.

In some embodiments, the solvent is prepared in situ. For example, an alkyl alkanoate may be prepared by mixing the corresponding alcohol with the corresponding carboxylic acid. In some embodiments, the alkyl alkanoate of formula (I) is prepared in situ by mixing an alcohol R¹—OH with a carboxylic acid R²COOH, wherein R¹ and R² are as defined above. In certain embodiments wherein the alkyl alkanoate is ethyl acetate, the ethyl acetate is prepared in situ by mixing ethanol with acetic acid. In some embodiments, the alkyl alkanoate is prepared in situ prior to the combination of the alkyl alkanoate solvent with the deoiled seedcake. In other embodiments, the alkyl alkanoate is prepared in situ with the deoiled seedcake. For example, in some embodiments, wherein the method comprises combining the deoiled seedcake with a solvent comprising ethyl acetate and the ethyl acetate is prepared in situ, the method comprises mixing the deoiled seedcake with ethanol and acetic acid.

Any combination of the extraction solvents described herein may also be used.

The solvent extraction step produces an extraction mixture, which then undergoes separation in step 120 to produce a miscella and the pongamia compositions described herein. In some variations, the miscella contains the liquid fraction of the extraction mixture (e.g., oil, solvent and any soluble compounds), whereas the pongamia composition largely is composed of the residual insoluble solid material (or meal) that remains from the deoiled seedcake. Any suitable solid-liquid separation methods may be employed for this separation step, including, for example, filtration and decanting.

In some embodiments, the miscella comprises a mixture of extracted oil, karanjin, pongamol, other furanoflavonoids, and solvent. In other embodiments, the miscella has a karanjin concentration of equal to or greater than 4000 ppm. In certain embodiments, the miscella has a karanjin concentration of equal to or greater than 4000 ppm as measured by the method described above. In certain embodiments, the miscella may be characterized by oil content, water content, moisture content, solids content, or other characteristics known in the art.

It should be understood that, in other variations, process 100 may include one or more additional steps. For example, the resulting pongamia composition may contain residual levels of the solvent. Accordingly, in some variations, the method may include a dry heating or toasting step to reduce the level of residual solvent. In other variations, the extraction mixture is irradiated with microwave irradiation after the combining step and prior to the separating step.

### Analytical Measurements

The determination of concentrations of karanjin, pongamol and other furanoflavanoids in the pongamia composition following treatment (dehulling, deoiling, solvent extraction) or at any stage in the treatment process (oilseeds with hull intact, dehulled oilseeds, deoiled seedcake), can be carried out by microwave-assisted solvent extraction with a suitable alkyl alkanoate solvent to obtain an alkyl alkanoate extract, which may then be subjected to various liquid chromatography and/or mass spectrometry techniques (such as HPLC/MS) to quantify the concentrations of karanjin, pongamol and other furanoflavanoids in the extract as a proxy for the pongamia. composition. Suitable alkyl alkanoate solvents include the alkyl alkanoate solvents described above, such as an alkyl alkanoate solvent selected from the group consisting of methyl methanoate, methyl ethanoate, methyl propanoate, methyl butanoate, methyl pentanoate, ethyl methanoate, ethyl ethanoate, ethyl propanoate, ethyl butanoate, ethyl pentanoate, propyl methanoate, propyl ethanoate, propyl propanoate, propyl butanoate, propyl pentanoate, butyl methanoate, butyl ethanoate, butyl propanoate, butyl butanoate, and butyl pentanoate, and any combinations thereof.

In some embodiments, following separation of the irradiated mixture into an extracted pongamia composition and a solvent extract, the method further comprises analyzing the solvent extract. As described herein, the step of analyzing the solvent extract involves measuring concentrations of karanjin and pongamol in the solvent extract, which serve as proxy measurements for the concentrations of karanjin and pongamol originally present in the pongamia composition. In some embodiments, the method comprises measuring concentrations of karanjin and pongamol in the solvent extract. In some embodiments, the method comprises measuring individual concentrations of one or more furanoflavonoids in the solvent extract. In certain embodiments, the method comprises measuring a karanjin concentration in the solvent extract. In other embodiments, the method comprises measuring a pongamol concentration in the solvent extract.

The measurement of the concentrations of karanjin, pongamol and other furanoflavonoids in the solvent extract may be performed using analytical separation and detection techniques known in the art. In some embodiments, the concentrations of karanjin, pongamol and other furanoflavonoids are determined by high-performance liquid chromatography (HPLC). In other embodiments, the concentrations of karanjin, pongamol and other furanoflavonoids are determined by HPLC-mass spectrometry (HPLC-MS). In certain embodiments, the concentrations of karanjin, pongamol and other furanoflavonoids are determined by HPLC-tandem mass spectrometry (HPLC-MS/MS). In some embodiments, the concentrations of karanjin, pongamol and other furanoflavonoids are determined by HPLC-ultraviolet-visible spectrophotometry (HPLC-UV-vis).

In some variations, the analytical methods as described herein may be referred to as a “microwave-assisted alkyl alkanoate solvent extraction analytical method”. In certain embodiments wherein a particular alkyl alkanoate is employed in the alkyl alkanoate solvent, the extraction may be referred to more specifically by the particular alkyl alkanoate being used. For example, in certain embodiments of the foregoing methods wherein the alkyl alkanoate solvent comprises ethyl acetate, the method of analyzing may be referred to as a “microwave-assisted ethyl acetate extraction analytical method”.

It should be recognized that reference to the “microwave-assisted alkyl alkanoate solvent extraction analytical method” includes embodiments in which the alkyl alkanoate solvent contains at least one alkyl alkanoate solvent and optionally one or more co-solvents that are not alkyl alkanoates. For example, “microwave-assisted ethyl acetate extraction analytical method” may refer to the use of an alkyl alkanoate solvent containing ethyl acetate and optionally one or more co-solvents,

### Uses of Pongamia Compositions

The pongamia compositions described, herein including compositions as produced according to any of the methods described herein) may be used as food or food ingredients suitable for feeding to humans and other animals. In some aspects, provided are methods for feeding any of the pongamia compositions described herein to an animal.

In some variations, the animal is a human. In other variations, the animal is a non-ruminant. As used herein, “non-ruminant” should be understood to include animals possessing a single-chambered stomach (i.e., monogastric). Examples of non-ruminant animals include, for example, poultry, swine, non-ruminant cattle, canines, felines, mice, and fish. In certain variations, the animal is poultry. In one variation, the animal is a chicken.

In one aspect, the pongamia compositions described herein may be used as a standalone feed or food. In another aspect, the pongamia compositions described herein may be utilized as feed ingredients or food ingredients within a larger feed or food composition.

In one aspect, provided herein is a food composition, comprising any of the pongamia compositions as described herein. In some embodiments, the food composition is a foodstuff (e.g., confection, condiment, cereal composition, baked good, baking good, cooking adjuvant, dairy product, dietary supplement, and tabletop sweetener composition), beverage, or other beverage product (e.g., beverage mix or concentrate). In certain other variations, the food composition is a grain product or pasta (e.g., health bar, grain-based bar), meat product (e.g., meat patty containing pongamia composition), dairy product (e.g., flavored milk drink, milkshake, protein shake, milk-based meal replacements, yogurt), plant protein products (e.g., egg products or analogs, meat alternatives or analogs), processed fruits and fruit juices (e.g., fruit juice, nectars, fruit-flavored drinks, fruit smoothies), processed vegetables and vegetable juices (e.g., vegetable juices and smoothies), soups and soup mixes (e.g., prepared soups, dry soup mixes, condensed soups), or snack foods (e.g., chips, popcorn, extruded snacks).

In some aspects, provided herein is an animal feed comprising any of the pongamia compositions described herein.

In certain aspects, provided is a poultry feed, comprising: a base feed; and any of the pongamia compositions described, herein. A suitable base feed for the feed compositions as described herein may be any non-pongamia-derived feedstock known in the art as forage or fodder, including, for example, hay, straw, silage, grains, legumes, food scraps and byproducts of food processing as suitable for the specific non-ruminant animal. In certain embodiments, the base feed may comprise one or more feeds selected from the group consisting of wheat feed, corn feed, barley feed, oat feed, soymeal, cottonseed meal, safflower seed meal, sunflower seed meal, peanut meal, groundnut meal, and hay. In certain embodiments, the base feed comprises wheat feed, corn feed, soymeal or any combination thereof.

In some variations, provided is a poultry feed, comprising: corn; a soybean supplement; and any of the pongamia compositions described herein, which is incorporated as a pongamia supplement. In some variations, the pongamia supplement and the soybean supplement are present in a weight ratio of between 1:1 and 1:25.

In other aspects, provided is an article of manufacture, such as a container comprising the pongamia compositions as described herein, or the feed comprising the pongamia compositions as described herein; and a label containing instructions for use of such pongamia compositions or feed.

In yet other aspects, provided is a kit comprising the pongamia compositions as described herein, or the feed comprising the pongamia compositions as described herein; and a package insert containing instructions for use of such pongamia compositions or feed.

### EXAMPLES

The presently disclosed subject matter will be better understood by reference to the following Examples, which are provided as exemplary of the invention, and not by way of limitation.

### Example A—Measurement Protocols

### Example A1: Microwave-Assisted Extraction Method (MAE) for Determination of Concentrations of Karanjin, Pongamol and Other Furanoflavanoids

The following example describes a general protocol for the measurement of karanjin and pongamol concentrations in a pongamia sample.

Microwave-assisted extraction of karanjin and pongamol. 0.5 g pongamia seedcake is added to a microwave extraction tube. Then, 15 mL of either ethyl acetate is added to the sample tubes and vortexed to mix. Next, the samples are extracted using a microwave extractor under the following conditions: 1) ramp for 15 minutes to 70° C., 2) hold at 70° C. for 10 minutes. Once cooled, the supernatant is filtered using filter paper in a Buchner funnel under a vacuum.

Standard solutions for HPLC. Commercially available karanjin and pongamol are mixed with methanol to produce the following HPLC standards: 0.05, 0.1, 0.2, 0.5, 1,0, 5.0, and 20.0 μg/mL.

HPLC instrumentation. HPLC analysis is conducted with a mobile phase consisting of: Solvent A (0.1% Formic acid in HPLC water) and Solvent B (0.1% Formic acid in acetonitrile). The injection volume is 2 μL and the flow rate was 0.75 mL/minute. The column is a C_{18 5} μm, 50×2mm HPLC column. All HPLC analyses are conducted in negative ion mode. The MS parameters are: curtain gas, 30 psi; collision gas, 4 psi; nebulizer gas (GS1), 50 psi; drying gas (GS2), 50 psi; ion spray voltage, 5000; temperature, 500° C.; declustering potential (DP), 51 V; entrance potential, 10V; collision energy (CE), 60 eV for karanjin and 30 eV for pongamol.

MS/MS quantification of karanjin and pongamol in extract. Multiple reaction monitoring (MRM) ion transitions are monitored for both karanjin and pongamol. The level of karanjin and pongamol present in the extracted samples is calculated using Analyst version 1.6.3. Briefly, the peak area of karanjin and pongamol in the extraction samples is compared with the peak area of the calibration standards to determine the parts per million of karanjin and pongamol.

### Example A2: Determination of Hull Removal Percentage and Tannin Content in Pongamia Samples

The following example describes a general protocol for the measurement of the percentage of hulls present and tannin content in a pongamia sample.

Hull Removal Percentage. A representative sample of oilseeds to be evaluated for percentage of hull removal is taken. The oilseeds and fragments thereof are sorted into two distinct groups based upon visual assessment of whether the individual oilseed or fragment has retained 50% or greater of its original hull covering. The two groups of oilseeds are separately weighed. The percentage of successful hull removal is calculated as the weight of oilseeds having less than 50% of the original hull covering intact over the sum of the weights for both groups of oilseeds, multiplied by 100%.

Tannin Content. The measurement protocol of tannin content in pongamia oilseeds and downstream pongamia products (e.g., deoiled seedcake) was carried out in accordance with ISO standard protocol for determination of tannin content in sorghum (ISO 9648, UV spectrophotometric method). The sample to be tested is shaken with dimethylformamide. The dimethylformamide mixture is centrifuged, and the supernatant isolated. Ferric ammonium citrate and ammonia are added to an aliquot of the supernatant liquid. The absorbance of the solution is determined by UV spectrophotometric measurement at 525 nm, and the tannic content determined using a calibration curve prepared using tannic acid.

### Example A3: Determination of Composition Profile

The following example describes general protocols to assay the compositional profile of a pongamia sample, for content of amino acids and other macronutrients.

Total protein. Total protein content is determined by placing the pongamia seedcake samples in the combustion chamber of a protein analyzer, measuring the total nitrogen content of the gas produced by combustion, and calculating the protein from the observed nitrogen content using a standard nitrogen conversion factor (protein content=6.25×nitrogen content).

Total ash. The total ash content is determined by placing the seedcake samples (2 g) into a crucible, dying the samples in an oven, ashing the samples in a muffle furnace at 600° C., and measuring the weight of the ash (AOAC 942.05 reference method).

Total moisture content. The total moisture content is determined by heating a weighed sample at 130° C. for 2 hours in a forced draft oven, and determining the difference in sample weight, with the percentage difference calculated as moisture content (AOCS BA 2A-38 reference method),

Total fat content. The total fat content was determined by solvent extraction under reflux with petroleum ether (AOCS BA3-38 reference method, modified).

Total carbohydrate. Total carbohydrate content is calculated as the remaining percentage of the pongamia seedcake (100%) less the sum of the total ash content (%), total protein content (%), total moisture content (90, and total fat (%).

### Example B—Large-Seale Extraction Methods

### Example B1—Preparation of Dehulled, Deoiled Pongamia Composition

### Thermomechanical Treatment

Pongamia pods were harvested and the oilseeds were removed from the pods. The isolated oilseeds were then subjected to various heat treatments at different temperatures (60° C., 120° C., 150° C., and 180° C.) for different durations of time (5-180 minutes). The thermal treatment was achieved by placing the pongamia oilseeds into aluminum baking trays (49.7cm×29.5cm×8.1 cm) with perforated bases at 75% capacity and placing the filled trays in a forced convection oven pre-heated to the indicated temperature.

Fourteen separate combination of temperatures and times were evaluated for the thermal treatment as shown in Table 8 below. In addition to the fourteen trials, a 100 kilogram-scale run was also carried out under the same conditions as trial number 013. As a control, pongamia oilseeds obtained from the same harvest group as the oilseeds evaluated in the fourteen trials were kept under ambient conditions without thermomechanical treatment.

Following thermal treatment, the heat-treated oilseeds were moved immediately into and passed through an impact huller (Codema VSH 2096, 5 hp motor, rotating impeller) for removal of hulls. The oilseeds from each of the fourteen trials passed through the impact huller. After dehulling, the oilseeds were removed from the impact huller and placed into a multi-aspirator (Kice 6E-6 Aspirator, 5 hp fan, cyclone, rotary airlock, 6″ ducting) to separate hulls from the dehulled oilseeds.

The percentage of dehulled oilseeds obtained from the procedure was assessed according to the protocol described in Example A2 above The tannin content of the dehulled test samples was also determined by the protocol described in Example A2 above.

Table 1 shows the results of percentage of pongamia oilseeds dehulled and measured tannin content of the dehulled seeds for the fourteen trials and large-scale trial conducted.

TABLE 1

| Trial | Temp | Time | Dehulled | Tannin |
|---|---|---|---|---|
| Number | (° C.) | (min) | (%) | content (%) |
| Control: | ambient | N/A | 0 | 0.87 |
| 001 | 60 | 60 | 43 | 0.496 |
| 002 | 60 | 120 | 65 | 0.305 |
| 003 | 60 | 180 | 53 | 0.409 |
| 004 | 60 | 60 | 58 | 0.365 |
| 005 | 60 | 120 | 64 | 0.313 |
| 006 | 60 | 150 | 71 | 0.252 |
| 007 | 60 | 180 | 60 | 0.348 |
| 008 | 120 | 20 | 59 | 0.357 |
| 009 | 120 | 35 | 71 | 0.252 |
| 010 | 150 | 15 | 71 | 0.252 |
| 011 | 150 | 20 | 73 | 0.235 |
| 012 | 180 | 5 | 67 | 0.287 |
| 013 | 180 | 10 | 68 | 0.278 |
| 014 | 180 | 15 | 69 | 0.270 |
| 100 kg Trial | ~180 | ~10 | ~68 | 0.29 |

### Mechanical Pressing and Solvent Extraction

Following the removal of hulls from the oilseeds, the dehulled oilseeds were subjected to mechanical pressing to remove pongamia oil. The dehulled oilseeds were passed through a small-scale mechanical expeller press (Taby Model 40A Expeller Press). The dehulled oilseeds processed under the conditions above were found to be compatible with the small-scale mechanical expeller press, resulting in an oil stream and a separate solid deoiled seedcake. Table 2 below shows the mass percentage of oil removed from a sample of dehulled oilseeds treated in Table 1 above.

TABLE 2

| Trial Number | Mass Percentage (%) of Oil Removed |
|---|---|
| 001 | 28.195 |
| 003 | 34.877 |
| 009 | 46.189 |
| 010 | 21.951 |
| 011 | 41.522 |
| 014 | 31.081 |

Dehulled, deoiled seedcake (trial number 013) was extracted with ethyl acetate in an immersion extractor (3-hour residence time, 5:1 solvent: feed ratio). After solvent extraction and removal of the miscella, the resulting ethyl acetate-extracted pongamia meal was analyzed for karanjin concentration, pongamol concentration and oil content as described in the protocols for Examples A1 and A3 above. The resulting ethyl acetate-extracted pongamia meal was measured as having 17 ppm karanjin, 10 ppm pongamol, and 0.80% residual oil.

1. A pongamia composition, comprising:
karanjin or pongamol, or both;
tannins;
digestible proteins;
carbohydrates;
antioxidants; and
minerals,
wherein the composition has:
(i) a karanjin content, if present, of less than or equal to 100 ppm;
(ii) a pongamol content, if present, of less than or equal to 100 ppm; and
(iii) a tannin content of less than or equal to 0.5% w/w.

2. The composition of claim 1, wherein the composition has a tannin content of less than or equal to 0.1 w/w %.

3. The composition of claim 1, wherein the composition is in the form of meal.

4. The composition of claim 1, wherein the composition is in the form of flour.

5. A method of preparing a pongamia composition according to claim 1, comprising:
heating pongamia oilseeds at a temperature between 25° C. and 200° C. for a suitable time to provide treated oilseeds;
dehulling the treated oilseeds to produce dehulled oilseeds;
mechanically pressing the dehulled oilseeds to produce a deoiled seedcake;
combining the deoiled seedcake with solvent to provide an extraction mixture, wherein the solvent comprises alkyl alkanoate or alcohol, or any combination thereof; and
separating the extraction mixture into a miscella and the pongamia composition.

6. The method of claim 5, wherein the mechanical pressing is performed by an expeller.

7. The method of claim 5, wherein the mechanical pressing is performed by an expander.

8. A method, comprising: feeding a pongamia composition according to claim 1 to a non-ruminant animal.

9. The method of claim 8, wherein the non-ruminant animal is a human.

10. The method of claim 8, wherein the non-ruminant animal is poultry.

11. The method of claim 10, wherein the poultry is a chicken.

12. A poultry feed, comprising:
a base feed; and
a pongamia composition according to claim 1.

13. A poultry feed, comprising:
corn;
a soybean supplement; and
a pongamia composition according to claim 1.

14. A food composition, comprising:
a pongamia composition according to claim 1.

15. The food composition of claim 14, wherein the food composition is a confection, condiment, cereal composition, baked good, baking good, cooking adjuvant, dairy product, dietary supplement, tabletop sweetener composition beverage, or other beverage product.
